(19) United States
(12) Patent Application Publication
(10) Pub. No.: US 2026/0249255 A1
(43) Pub. Date: Aug. 27, 2026

(54) Piston Foamer

(71) Applicant: ABC Manufacturing, LLC dba ABC Wash Systems, Rochester Hills, MI (US)

(72) Inventor: Ismael Mosa-Basha, Rochester Hills, MI (US)

(21) Appl. No.: 19/544,418

(22) Filed: Feb. 19, 2026

Related U.S. Application Data
(60) Provisional application No. 63/760,261, filed on Feb. 19, 2025.

(51) Int. Cl. B01F 23/235; B01D 39/20; B01F 23/232; B01F 25/431; B01F 35/00; B01F 35/75; B01F 101/00; B60S 3/04

(52) U.S. Cl. CPC B01F 23/235; B01D 39/2027; B01F 23/2322; B01F 25/43171; B01F 35/187; B01F 35/7547; B01F 2101/4505; B60S 3/04

(57) ABSTRACT

A device for generating foam comprising a metallic housing having a first terminating end and a second terminating end, a removable foaming insert received within the metallic housing, wherein the removable foaming insert comprises a linear rigid support, at least one mixing wheel, at least one metallic filter media, and a locking pin, a side welded mounting bracket located along an exterior of the metallic housing, a hinge connected cap hingably attached to the first terminating end of the metallic housing and capable of allowing access to an interior of the metallic housing, a first adjustable flow rate inlet for compressed air capable of providing compressed air to the foaming insert, a second adjustable flow rate inlet for solution located adjacent the first adjustable flow rate inlet and capable of providing solution to the foaming insert, and at least one metallic discharge located at the second terminating end of the metallic housing and including a tube with one or more adjustable openings.

### FIELD OF INVENTION

The present teachings relate generally to devices for holding, forming, and dispensing liquid and/or foamed components. More particularly, the present teachings relate to improved components for car wash systems that improve function and eliminate plastic components that must be frequently replaced.

### BACKGROUND

Traditional car wash foamers often utilize plastic components in their construction. Plastic components are not durable when exposed to the chemicals used in car wash systems. Plastic is prone to cracking and decomposition under such conditions. Plastic also needs to be replaced when damaged. There is a need for a more durable and reliable solution which incorporates stronger, more durable materials, such as metallic materials. Metallic components can be repaired instead of replaced when used in car wash foamers and can also have additional components welded thereto.

United States Patent No. 9,132,393 discloses a foaming device but fails to provide any solutions for more durable devices that are not regularly replaced.

### SUMMARY OF INVENTION

The present teachings provide a device for generating foam wherein the device comprises a metallic housing having a first terminating end and a second terminating end, a removable foaming insert received within the metallic housing, wherein the removable foaming insert comprises a linear rigid support, at least one mixing wheel, at least one metallic filter media, and a locking pin; a side mounting bracket located along an exterior of the metallic housing; a cap hingably attached to the first terminating end of the metallic housing that may be capable of allowing access to an interior of the metallic housing; a first adjustable flow rate inlet for compressed air that is capable of providing compressed air to the foaming insert; a second adjustable flow rate inlet for solution located adjacent the first adjustable flow rate inlet that is capable of providing solution to the foaming insert; and at least one metallic discharge located at the second terminating end of the metallic housing.

The removable foaming insert may comprise a linear rigid support in the form of a rod with an eyelet located on the exterior of the linear rigid support.

The removable foaming insert may comprise the rod with the eyelet and a plurality of mixing wheels arranged in a fixed position along the linear rigid support.

The removable foaming insert may comprise the rod with the eyelet and a plurality of metallic filter media arranged in a fixed position along the linear rigid support.

The removable foaming insert may comprise the rod with the eyelet, a plurality of mixing wheels, and a plurality of metallic filter media that may be arranged in a fixed alternating position along the linear rigid support.

The device may include one or more switches on each of the first or second flow rate inlets.

The side mounted bracket may be welded to the metallic housing.

The device may include a locking pin at a bottom terminating end of the rigid support.

The device may include a discharge tube for connecting to the second terminating end of the metallic housing.

The discharge tube may be metallic.

The discharge tube may include a plurality of openings.

The openings may be arranged in a line.

The openings may be arranged randomly.

The filter media may be stainless steel and capable of being removed, washed, and replaced onto the rigid support.

The filter media, mixing wheels, or both may be stainless steel or plastic.

The cap may include a rubber seal.

The second terminating end may be free of any cap structure.

The connected cap may be connected via a hinge that is welded to the metallic housing, the cap, or both.

One or more of the first and second adjustable flow rate inlets may be welded to the metallic housing.

One or more of the first and second adjustable flow rate inlets may include a first portion and a second portion wherein the first portion is substantially perpendicular to the metallic housing and the second portion is substantially parallel to the metallic housing.

The metallic housing may have a length along its longest dimension that is less than 60 cm, less than 50 cm, less than 40 cm, or even less than 30 cm.

The teachings herein are further directed to a foaming insert comprising a rigid support, a plurality of stainless steel filter media located on the rigid support, a plurality of mixing wheels located on the rigid support, wherein the material of the filter media allows for removal of the filter media from the rigid support, cleaned, and replaced onto the rigid support.

There may be less than 10, less than 9, or even less than 8 stainless steel filter media on the foaming insert.

### BRIEF DESCRIPTION OF THE DRAWINGS

FIG. 1 shows a prospective view of an exemplary foamer in accordance with the present teachings.

FIG. 2 shows a front elevational view of the foamer of FIG. 1

FIG. 3 shows a cross sectional view of the foamer of FIG. 1

FIG. 4 shows a cross sectional view of the foamer of FIG. 1

FIG. 5 shows a removable insert for locating inside the foamer of FIG. 1.

FIG. 6 shows the removable insert of FIG. 5 including a filter media within.

FIG. 7 shows the foamer of FIG. 1 connected to a discharge tube spray device.

FIG. 8 shows the foamer of FIG. 1 connected to an alternative discharge tube spray device

### DETAILED DESCRIPTION OF THE INVENTION

The explanations and illustrations presented herein are intended to acquaint others skilled in the art with the invention, its principles, and its practical application. Accordingly, the specific embodiments of the present disclosure as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The devices described herein provide for superior corrosion resistance in car wash settings, where water and cleaning chemicals can easily cause damage to traditional plastic devices, avoiding cracking, wear, and other damage. The durability of the metallic devices also reduces the frequency of part replacements and maintenance interventions. Plastic waste is also eliminated.

The devices described herein include a hinged cap that is integrally formed or weldably attached to a metallic housing at a top terminating end of the housing. This cap allows for secure sealing while also avoiding the common of issue of misplaced caps. The metallic nature of the device also facilitates a welded side-mounting kit, facilitating easy installation and maintenance in a car wish system. The metallic housing may be substantially hollow for receiving liquids and air. The metallic housing may have a substantially rounded cross section. The metallic housing may have a longitudinal axis that extends along its longest dimension. The length of the metallic housing along its longest dimension may be less than 100 mm, less than 80 mm, less than 60 mm, less than 40 mm, or even less than 20 mm. The metallic housing may have an exterior wall having a wall thickness of greater than 0.5 mm, greater than 1 mm, greater than 2 mm, greater than 3 mm, greater than 5mm, or even greater than 8 mm. The metallic housing may have a diameter that is less than 60 mm, less than 40 mm, less than 20 mm, or even less than 10 mm.

The metallic housing may also include integrated inlets for compressed air and liquid materials to enable precise control of flow rates to optimize foaming performance. The integrated inlets may each include a switch to increase, decrease, or stop the flow of liquid or air as needed for desired foaming function. The integrated inlets may be shaped and located so that the distance to the foaming insert is minimized and any liquid travels downward to promote movement even without significant pressure. The integrated inlets may be welded to the metallic housing. The integrated inlets may have a first portion that extend outward from the metallic housing and is substantially perpendicular to a longitudinal axis of the metallic housing. The integrated inlets may have a second portion that extend upward from the first portion and is substantially parallel to a longitudinal axis of the metallic housing.

The foamer devices described herein may further be adapted to connect to discharge tubes that are equipped with interchangeable nozzles to support a variety of different spray patterns. The discharge tubes may be shaped to directly engage with the bottom terminating end of the metallic housing or with an adapter shaped to connect the metallic housing with a discharge tube. The discharge tubes can include any arrangement of openings for distributing foam. The openings may be any size.

The foamer devices may include only a cap on the top terminating end and may be free of any cap on the bottom terminating end. The bottom terminating end may be open and adapted for connection with either a discharge tube or an adapter for connecting to a discharge tube.

The foamer devices described herein provide for a long-term solution for car wash systems that avoids additional plastic waste and minimizes the need to repair and replace the foamer devices on a regular basis. The devices include a cap that is connected to a metallic housing of the device via a hinge to allow for easy access to a cavity within the device for receiving a removable foaming insert. The removable foaming insert may be an insert having metallic filter media that can be easily cleaned and then located back into the cavity.

The removable foaming insert may include a linear rigid support, which may be metallic (e.g., steel, aluminum, brass, titanium, or any other suitable metal). The linear rigid support may be fitted with alternating mixing wheels and filter media. The mixing wheels and filter media facilitate the foaming process by facilitating the mixing movement of liquid materials that are located into the cavity of the metallic housing. The removable insert may move include a piston mechanism to improve the mixing process, resulting in optimal foam density and distribution. A bottom terminating end of the foaming insert may include a locking pin for maintaining the mixing wheels and filter media in a desired location along the rigid support. Upon removal of the locking pin, the filter media and mixing wheels can be removed, cleaned, and replaced as needed. The top terminating end of the foaming insert may include an eyelet for easy of removal of the foaming insert from the metallic housing. The eyelet may be any shape that allows for ease in grabbing and pulling and/or pushing the revvable insert. They eyelet may be pushed far enough int the metallic housing so that the hinged cap does not contact the eyelet upon closing. Alternatively, the hinged cap may engage the eyelet when closed to assist in secure sealing of the device. The removable insert may include less than 12, less than 10, or even less than 8 individual filer media.

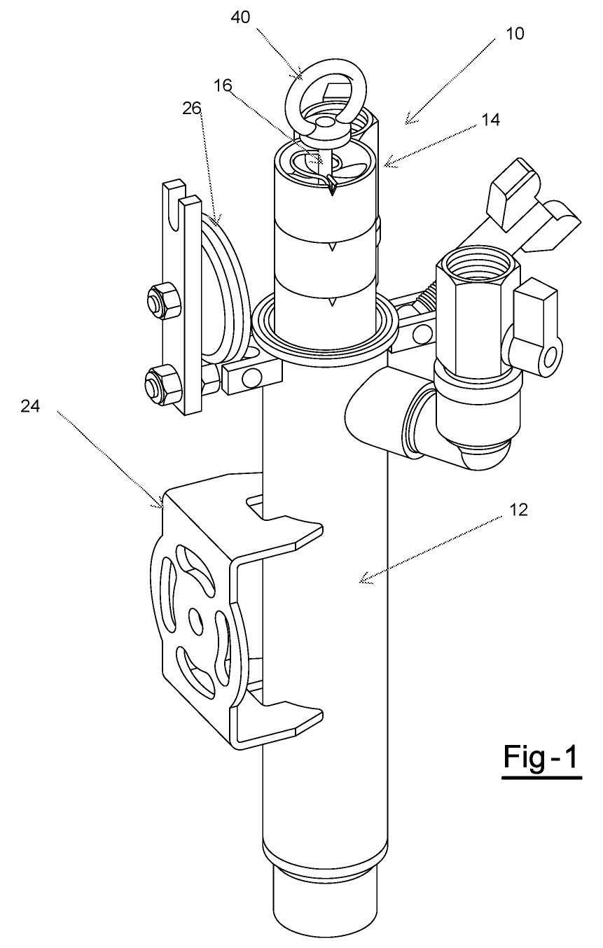

FIG. 1 shows a side view of the device 10 with the metallic housing 12 supporting the side mounting bracket 24 and hinge connected cap 26. FIG. 1 also shows the eyelet 40 at the top of the linear rigid support 16 wherein the removable foaming insert 14 is visible along the linear rigid support 16.

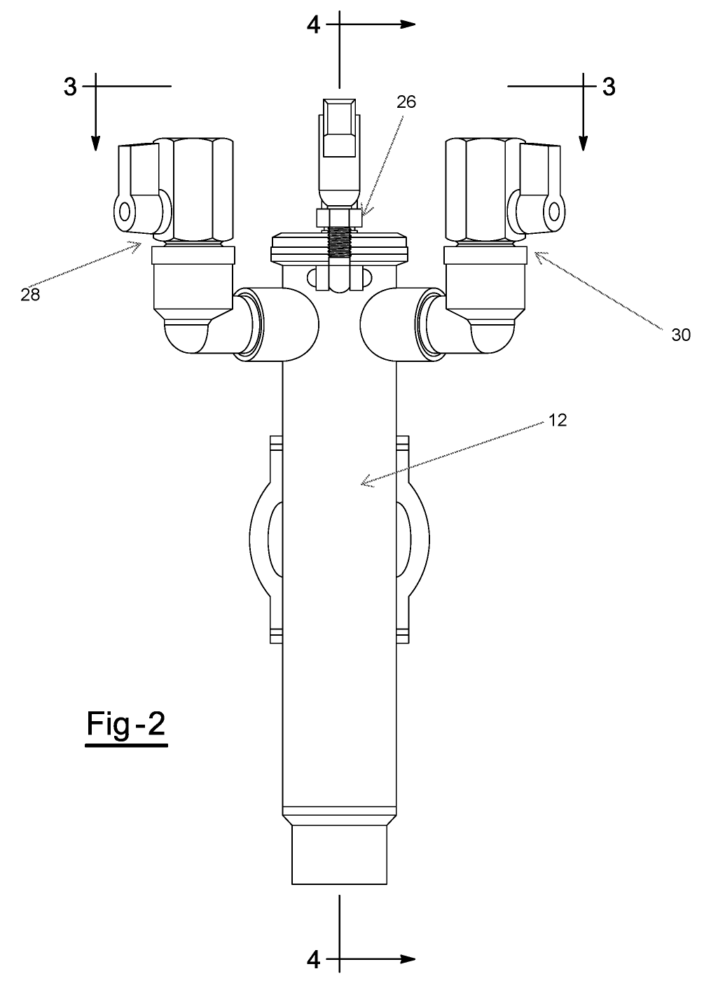

FIG. 2 shows the front view of the metallic housing 12 with the hinge connected cap 26 at the top of the metallic housing 12. FIG. 2 also shows the first adjustable flow rate inlet 28 and the second adjustable flow rate inlet 30 on either side of the hinge connected cap 26.

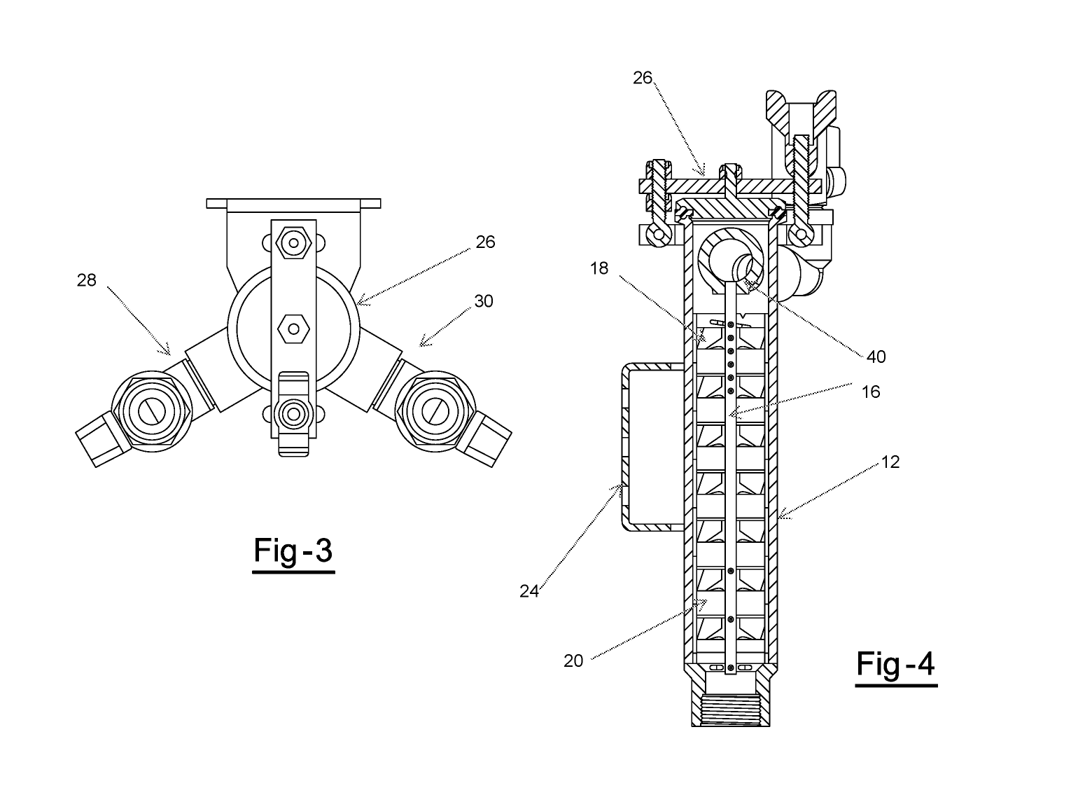

FIG. 3 shows the top view of the cap 26 with the first adjustable flow rate inlet 28 and the second adjustable flow rate inlet 30.

FIG. 4 shows the interior of the housing 12 containing the removable foaming insert 14 having a mixing wheel 18 alternating with the metallic filter media 20 along the linear rigid support 16. The eyelet 40 facilitates removal and insertion of the foaming insert via an opening 42 covered by the cap 26. The side mounting bracket is connected to the housing 12.

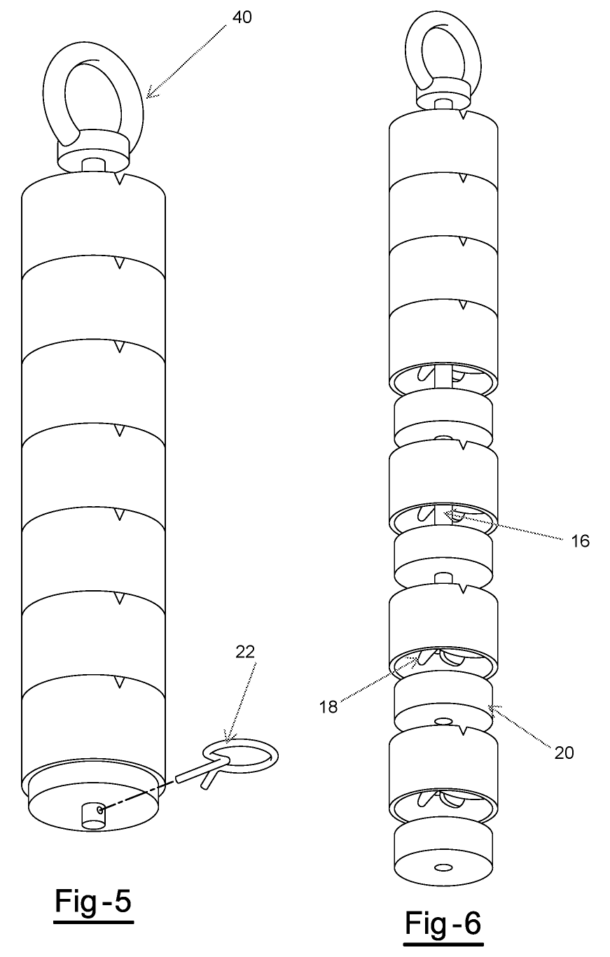

FIG. 5 shows the removable foaming insert 14 with the eyelet 40 at the top and the locking pin 22 at the bottom.

FIG. 6 shows the removable foaming insert 14 with the eyelet 40 at the top and the mixing wheel 18 and metallic filter media 20 along the linear rigid support 16.

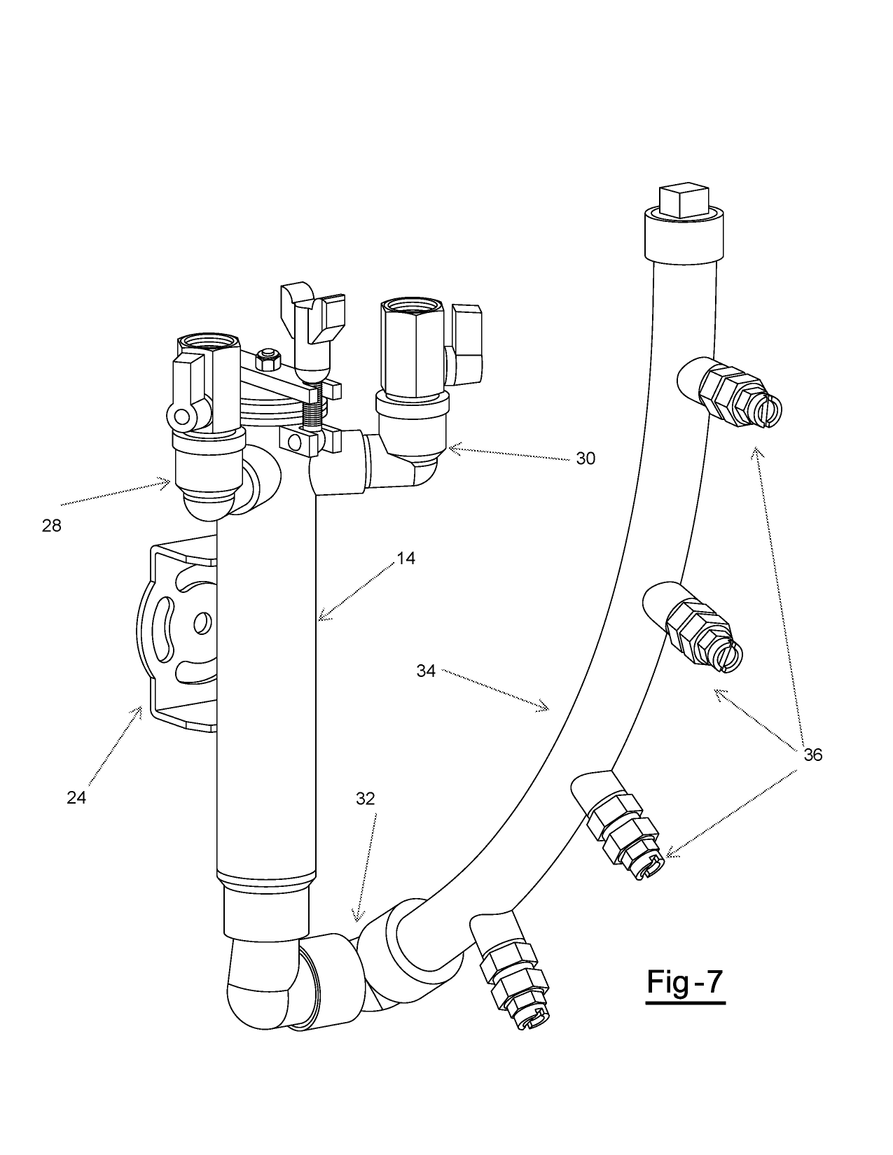

FIG. 7 shows the metallic housing 12 with the side mounting bracket 24 and the first adjustable flow rate inlet 28 and second adjustable flow rate inlet 30 at the top of the metallic housing 12. FIG. 7 also shows the metallic discharge 32 at the bottom of the metallic housing 12 connecting a discharge tube 34 with the adjustable openings 36.

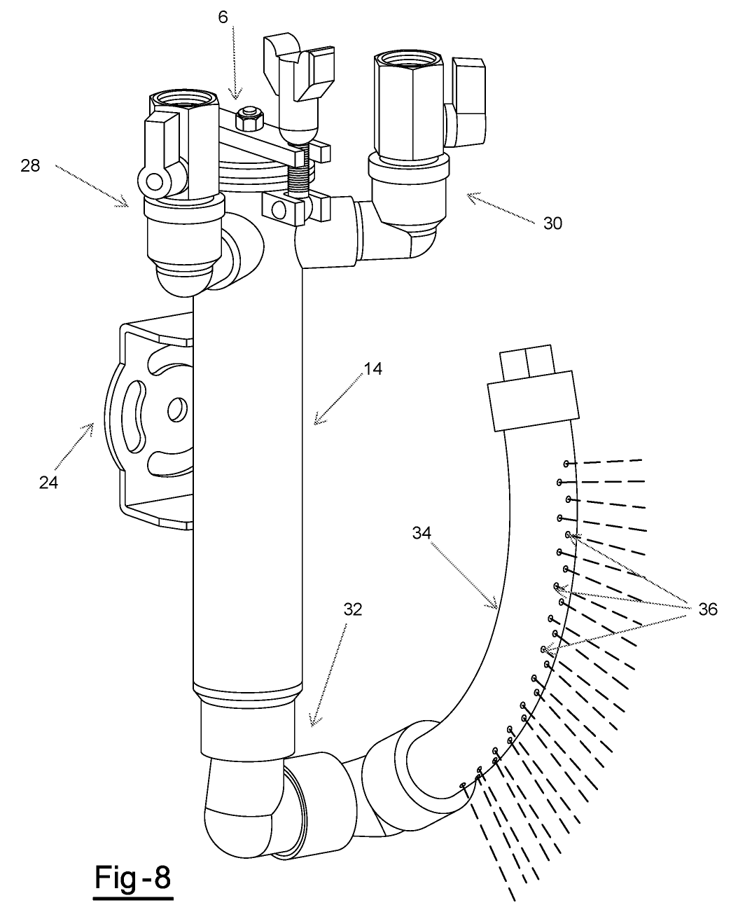

FIG. 8 gives a similar side view to FIG. 7, showing the cap 26, the side mounting bracket 24 on the side of the metallic housing 12 and the first adjustable flow rate inlet 28 and second adjustable flow rate inlet 30 at the top of the metallic housing 12. It also shows the metallic discharge 32 at the bottom of the metallic housing 12 connecting the discharge tube 34 with another variation of the adjustable openings 36.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are considered to be expressly stated in this application in a similar manner. As can be seen, the teaching of amounts expressed as "parts by weight" herein also contemplates the same ranges expressed in terms of percent by weight. Thus, an expression in the Detailed Description of the Invention of a range in terms of at "x parts by weight of the resulting polymeric blend composition" also contemplates a teaching of ranges of same recited amount of "x in percent by weight of the resulting polymeric blend composition."

Unless otherwise stated, all ranges include both endpoints and all numbers between the endpoints. The use of "about" or "approximately" in connection with a range applies to both ends of the range. Thus, "about 20 to 30" is intended to cover "about 20 to about 30", inclusive of at least the specified endpoints.

The disclosures of all articles and references, including patent applications and publications, are incorporated by reference for all purposes. The term "consisting essentially of" to describe a combination shall include the elements, ingredients, components or steps identified, and such other elements ingredients, components or steps that do not materially affect the basic and novel characteristics of the combination. The use of the terms "comprising" or "including" to describe combinations of elements, ingredients, components or steps herein also contemplates embodiments that consist essentially of, or even consists of, the elements, ingredients, components or steps. By use of the term "may" herein, it is intended that any described attributes that "may" be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of "a" or "one" to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

It will be appreciated that concentrates or dilutions of the amounts recited herein may be employed. In general, the relative proportions of the ingredients recited will remain the same. Thus, by way of example, if the teachings call for 30 parts by weight of a Component A, and 10 parts by weight of a Component B, the skilled artisan will recognize that such teachings also constitute a teaching of the use of Component A and Component B in a relative ratio of 3:1. Teachings of concentrations in the examples may be varied within about 25% (or higher) of the stated values and similar results are expected. Moreover, such compositions of the examples may be employed successfully in the present methods.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not. It is understood that the above description is intended to be illustrative and not restrictive. Many embodiments as well as many applications besides the examples provided will be apparent to those of skill in the art upon reading the above description.

The explanations and illustrations presented herein are intended to acquaint others skilled in the art with the invention, its principles, and its practical application. Those skilled in the art may adapt and apply the teachings in their numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

1. A device for generating foam comprising:
an elongated metallic housing having a first terminating end and a second terminating end;
a removable foaming insert received within the metallic housing, wherein the removable foaming insert comprises a linear rigid support, at least one mixing wheel, at least one metallic filter media, and a locking pin;
a side mounting bracket located along an exterior of the metallic housing;
a connected cap hingably attached to the first terminating end of the metallic housing and capable of allowing access to an interior of the metallic housing;
a first adjustable flow rate inlet for compressed air capable of providing compressed air to the foaming insert;
a second adjustable flow rate inlet for solution located adjacent the first adjustable flow rate inlet and capable of providing solution to the foaming insert; and
at least one metallic discharge located at the second terminating end of the metallic housing.

2. The device of claim 1, wherein the removable foaming insert comprises a linear rigid support in the form of a rod with an eyelet located on the exterior of the linear rigid support.

3. The device of claim 2, wherein the removable foaming insert comprises the rod with the eyelet and a plurality of mixing wheels arranged in a fixed position along the linear rigid support.

4. The device of claim 3, wherein the removable foaming insert comprises the rod with the eyelet and a plurality of metallic filter media arranged in a fixed position along the linear rigid support.

5. The device of claim 2, wherein the removable foaming insert comprises the rod with the eyelet, a plurality of mixing wheels, and a plurality of metallic filter media arranged in a fixed alternating position along the linear rigid support.

6. The device of claim 4, wherein any one of the metallic housing, the removable insert, the filter media, the rigid support, the first or second flow rate inlets, or the connected cap are formed of a stainless steel material.

7. The device of claim 1, including one or more switches on each of the first or second flow rate inlets.

8. The device of claim 1, wherein the side mounted bracket is welded to the metallic housing.

9. The device of claim 2, including a locking pin at a bottom terminating end of the rigid support.

10. The device of claim 1, including a discharge tube for connecting to the second terminating end of the metallic housing.

11. The device of claim 10, wherein the discharge tube is metallic.

12. The device of claim 11, wherein the discharge tube include a plurality of openings.

13. The device of claim 12, wherein the openings are arranged in a line.

14. The device of claim 12, wherein the openings are arranged randomly.

15. The device of claim 1, wherein the filter media are stainless steel and capable of being removed, washed, and replaced onto the rigid support.

16. The device of claim 1, wherein the filter media, mixing wheels, or both are stainless steel or plastic.

17. The device of claim 2, wherein one or more of the first and second adjustable flow rate inlets include a first portion and a second portion wherein the first portion is substantially perpendicular to the metallic housing and the second portion is substantially parallel to the metallic housing.

18. The device of claim 1, wherein the second terminating end is free of any cap structure.

19. The device of claim 1, wherein the connected cap is connected via a hinge that is welded to the metallic housing, the cap, or both.

20. A foaming insert comprising:
a rigid support;
a plurality of stainless steel filter media located on the rigid support;
a plurality of mixing wheels located on the rigid support;
wherein the material of the filter media allows for removal of the filter media from the rigid support, cleaned, and replaced onto the rigid support.
